(19) United States
(12) Patent Application Publication
(10) Pub. No.: US 2017/0159526 A1
(43) Pub. Date: Jun. 8, 2017

(54) APPARATUS AND METHOD FOR PRODUCING AMMONIA FOR EXHAUST GAS AFTERTREATMENT

(71) Applicant: Baumot AG, Glattpark (CH)

(72) Inventor: Henning Middelmann, Herdecke (DE)

(21) Appl. No.: 15/321,425

(22) PCT Filed: Jun. 3, 2015
(86) PCT No.: PCT/EP2015/062397

§ 371 Date: Feb. 16, 2017

(30) Foreign Application Priority Data
Jun. 25, 2014 (DE) 10 2014 108 877.8

(51) Int. Cl. F01N 3/20; F01N 3/30; F01N 3/28; F01N 3/029; F02B 37/18

(52) U.S. Cl. CPC F01N 3/2066; F01N 3/029; F01N 3/2013; F02B 37/18; F01N 3/2892; F01N 3/30; F01N 2240/16; F01N 2240/38; F01N 2610/02

(57) ABSTRACT

The invention relates to a device for generating ammonia from an ammonia precursor solution, having a reaction space with an inflow connector through which a gas flow can flow into the reaction space, with an outflow connector through which an ammonia-containing gas flow can exit the reaction space, and with a supply device by way of which an ammonia precursor solution can be supplied into the reaction space, wherein the inflow connector is connected to a first connecting line through which air can flow from an intake line of an internal combustion engine into the reaction space, and wherein the inflow connector is furthermore connected to a second connecting line through which exhaust gas can flow from an exhaust line of the internal combustion engine into the reaction space.

The invention relates to a device and a method for generating ammonia from an ammonia precursor solution. A device of said type may for example be used for generating ammonia that is utilized for exhaust-gas purification in an exhaust-gas treatment device. Exhaust-gas treatment devices in which ammonia is utilized for exhaust-gas purification are for example commonly used for the purification of exhaust gases of diesel internal combustion engines in motor vehicles. Nitrogen oxide compounds in the exhaust gas of the internal combustion engine are reduced with the aid of the ammonia. As ammonia precursor solution, use is typically made of urea-water solution. An ammonia precursor solution of said type has the advantage over ammonia that it can be stored in a tank without problems. What is particularly commonly used is a urea-water solution with a urea content of 32.5%, which is available under the trade name AdBlue®.

The conversion of ammonia precursor solution into ammonia generally necessitates special technical measures Ammonia is obtained from the ammonia precursor solution for example at certain temperatures. The conversion takes place in a particularly effective manner in a temperature range between 150° C. and 550° C.

The temperature range for the conversion of ammonia precursor solution into ammonia may be expanded, and in particular lowered, by the presence of catalytic converters, such that the conversion can even take place in a temperature range between 140° C. and 250° C. The thermal conversion of ammonia precursor solution into ammonia is normally referred to as thermolysis or as thermolytic conversion. If the conversion is additionally assisted by way of a catalytic converter, this is referred to as hydrolysis or hydrolytic conversion.

In any case, the ammonia precursor solution must be heated in order to be converted into ammonia. Heat energy is required for this purpose. Normally, the ammonia precursor solution is thus metered directly into the exhaust gases of an internal combustion engine. The heating is then realized by way of the exhaust gases. Here, there is however the problem that, in particular in the case of diesel internal combustion engines, the exhaust gases are commonly at relatively low temperatures and therefore (at least in many load states of the diesel engine) cannot provide enough thermal energy to convert ammonia precursor solution into ammonia in an effective manner This problem has generally, in the past, been counteracted with the aid of suitable measures for increasing the temperature in an exhaust-gas treatment device. The heating of the exhaust gases is particularly commonly performed with the aid of an electric heater. A further known method for increasing the temperature of the exhaust gases is the intentional shifting of the operating point of the internal combustion engine such that the internal combustion engine generates exhaust gases at relatively high temperature. Here, there is however the problem that, in particular if ammonia precursor solution is not fully converted into ammonia, deposits of the ammonia precursor solution can form in the exhaust-gas treatment device. Such deposits can (permanently) adversely affect the exhaust gas purification or even damage the exhaust-gas treatment device. Furthermore, a situation may arise in which the exhaust gas temperature is too low to be able, by way of the described known measures for increasing the temperature, to adequately increase the exhaust-gas temperature for the conversion of ammonia precursor solution into ammonia. This applies in particular to cold-start phases of an internal combustion engine because, in cold-start phases, the exhaust gases of the internal combustion engine are intensely cooled by the thermal mass of the internal combustion engine and of the exhaust-gas treatment device.

A further problem in devices for providing ammonia is also that such devices can warm up to such an extent that the temperature is too high for the conversion reaction of ammonia precursor solution into ammonia. A critical upper limit for the temperature of 450° C. to 550° C. has already been mentioned above. At higher temperatures, the ammonia that is produced possibly directly breaks down again, or is converted into nitrogen oxide. It is therefore often necessary not only for the lower limit temperature to be attained in a device for generating ammonia, but also for an upper limit temperature not to be exceeded. In particular in the presence of high exhaust-gas temperatures owing to full-load phases of an internal combustion engine of long duration, temperatures may be reached at which reliable provision of ammonia is no longer possible. Specifically in such phases, it is however particularly important for ammonia to be reliably provided, because in such phases, internal combustion engines exhibit high emissions of nitrogen oxides.

Taking this as a starting point, it is an object of the present invention to describe an improved device for generating ammonia, which device permits reliable provision of ammonia even in the presence of high exhaust-gas temperatures. Furthermore, it is sought to propose a particularly advantageous method for operating a device of said type.

Said objects are achieved by means of an apparatus according to the features of claim 1 and by means of a method according to the features of claim 10. Further advantageous embodiments of the invention are specified in the dependent claims. The features specified individually in the claims may be combined with one another in any desired technologically meaningful way and may be supplemented by explanatory facts from the description, with further embodiments of the invention being highlighted.

The invention relates to a device for generating ammonia from an ammonia precursor solution, having a reaction space with an inflow connector through which a gas flow can flow into the reaction space, and with an outflow connector through which an ammonia-containing gas flow can exit the reaction space. Furthermore, a supply device is provided by way of which an ammonia precursor solution can be supplied to the reaction space. The inflow opening is connected to a first connecting line, through which air can flow from an intake line of an internal combustion engine into the reaction space, and is furthermore connected to a second connecting line, through which an exhaust-gas flow can flow into the reaction space.

The device is designed in particular as a component which is positioned externally or adjacent to an exhaust line with the main exhaust-gas flow of an internal combustion engine. The device is typically connected to a line branch which branches off from an exhaust line of an exhaust-gas treatment device of an internal combustion engine. Said line branch then opens into the inflow connector of the device. The line branch preferably branches from the exhaust-gas treatment device upstream of an exhaust gas turbocharger which is integrated in the exhaust line. A supply line is typically connected to the outflow connector of the device, via which supply line the ammonia-containing gas flow generated by the device is supplied to the exhaust-gas treatment device. The supply line opens, preferably downstream of the turbocharger in the exhaust-gas flow direction, into the exhaust-gas treatment device of the internal combustion engine. The device is thus particularly preferably integrated in an exhaust-gas bypass which bypasses the turbocharger. This has the advantage that a pressure difference prevails between the inflow connector and the outflow connector, which pressure difference ensures that the exhaust gas that is conducted into the inflow connector is forced through the device with a pressure gradient.

The reaction space refers to a (at least one) cavity within the device, in which cavity the conversion reaction of ammonia precursor solution into ammonia takes place. The reaction space may comprise a component or various functional components which promote the conversion reaction. These are for example (a) special catalytic converters, (b) structures which influence the exhaust-gas flow and the movement of the ammonia and of the ammonia precursor solution in the reaction space, and/or (c) sensors etc.

The supply device preferably comprises at least one nozzle by way of which the ammonia precursor solution can be supplied into the reaction space. The supply device preferably furthermore comprises at least one valve by way of which the supply of ammonia precursor solution can be (actively) controlled. This may be realized for example by way of an adaptation of the opening time of the valve. Here, the duration of the opening time is proportional to the supplied amount of ammonia precursor solution. The supplied amount of ammonia precursor solution may also be controlled by way of the number of opening processes of the valve. The valve is preferably operated with a fixed opening time, and if a certain amount of ammonia precursor solution is to be supplied, a corresponding number of opening processes (proportional to the amount) is performed.

Here, both a first connecting line for the supply of air from an intake line and a second connecting line for the supply of exhaust gas from an exhaust line can be connected to the inflow connector of the device. The gas flow entering the reaction space of the device is thus composed selectively of air and/or of exhaust gas. This makes it possible to regulate the temperatures of the inflowing gas flow in a particularly accurate manner If the temperature of the available exhaust gas is too high, such that no conversion of the ammonia precursor solution into ammonia is possible, it is also possible, instead of the exhaust gas from an exhaust line, for air from an intake line of the internal combustion engine to be supplied to the reaction space.

The supply device preferably has two connectors, wherein a first connecting line for air is connected to a first connector, and a second connecting line for exhaust gas is connected to a second connector. It is also possible for the supply device to have only one connector, to which both connecting lines are connected (in a selectively closable manner). In a further embodiment, a common connecting line is arranged on a connector of the device, and the first connecting line for air and the second connecting line for exhaust gas are merged with one another already upstream of the connector.

The device is particularly advantageous if, between the first connecting line and the second connecting line, there is arranged a valve by way of which selectively exhaust gas or air can be supplied to the reaction space.

Said valve is in this case preferably a constituent part of the supply device. By way of the valve, it is possible to switch between the metering of air and the metering of exhaust gas. The valve is preferably controllable by a control unit. Within the device, there is preferably situated a sensor by way of which the temperature of the device can be monitored. In a manner dependent on the temperature detected by the sensor, the valve can be controlled in order to selectively supply air or exhaust gas to the device.

The device is furthermore advantageous if, by way of the valve, a mixture of air and exhaust gas can be generated which can be supplied to the reaction space.

The valve is then preferably in the form of a continuously adjustable valve by way of which one flow (either the air flow or the exhaust-gas flow which enters the reaction space is a gas flow at the inflow connector) is selectively throttled. By way of a valve of said type, it is possible for the mixing ratio between air and exhaust gas in the gas flow to be adjusted in a precise (and continuously variable) manner. In this way, in particular, a continuously variable adaptation of the temperature of the gas flow entering the reaction space is possible. A continuously adjustable valve of said type is particularly preferably controllable, by way of a control unit and a sensor in the device, in a manner dependent on the temperature in the device.

The device is furthermore advantageous if an electric heater is arranged in the reaction space.

By way of an electric heater, the temperature of the device can be increased (briefly and over a predefinable heating period) if neither the available exhaust gas nor the available air is at a temperature sufficient to permit the conversion of ammonia precursor solution into ammonia in the device. This is the case in particular during a cold-start phase of an internal combustion engine, because then, the exhaust-gas flow is not yet at a temperature sufficient for the conversion of ammonia precursor solution into ammonia.

In conjunction with a heater, a particular advantage of the device can be specified, which arises in particular from the fact that, through the inflow connector, the device can also be supplied with air rather than exhaust gas. By way of the operation of an electric heater in the device, it is possible for ozone to be generated in the device if air is supplied to the inflow connector of the device. In an exhaust-gas treatment device, ozone may be utilized for example to break up hydrocarbon deposits (for example soot) in the exhaust-gas treatment device. This is highly expedient in particular for the cleaning of a particle filter in the exhaust gas treatment device. The device can thus be configured as a combined device for generating ammonia and ozone. For the generation of ozone, the electric heater is activated, and an air flow is supplied as a gas flow to the device. For the generation of ammonia, ammonia precursor solution is supplied to the device, and at the same time, the temperature of the device is, by way of regulation of the gas flow and/or the electric heater, kept in a temperature range suitable for the generation of ammonia. For the generation of ozone, the heater is normally operated with the maximum possible power. The air flow is furthermore preferably set such that a dwell time of the air in the device is realized which is sufficient for ozone to be formed. This may be realized for example by way of targeted throttling of the air flow. For example, a throttle valve may be arranged in the first connecting line, by way of which throttle valve the air supply can be throttled in order to increase the dwell time of the air in the device.

It is particularly advantageous if the electric heater simultaneously forms an impingement structure within the device, which impingement structure is impinged on by the ammonia precursor solution if the latter has been metered by way of the supply device. The increased temperature within the device is required in particular in the region of the impingement structure because it is there that cooling by way of the impinging ammonia precursor solution occurs. Furthermore, an increased temperature is required specifically on the impingement structure in order to effect the conversion reaction of the ammonia precursor solution.

The device is particularly advantageous if the electric heater is an electrically heatable honeycomb body.

An electrically heatable honeycomb body is suitable in particular for forming, with the aid of an electric heater, an impingement structure which can at the same time be flowed through by the exhaust-gas flow. An electric honeycomb body may for example be a heating coil formed from metallic foils, which heating coil spans the cross section of the device or a cross section of the reaction space of the device.

Furthermore, the device is advantageous if the inflow connector is arranged tangentially at the reaction space.

By way of a tangential arrangement of the inflow connector, it can be ensured that the gas flowing into the inflow connector generates a vortex flow within the device. Said vortex flow firstly has the advantage that particularly good mixing of ammonia precursor solution and the gas flow takes place. Furthermore, the vortex flow centers the ammonia precursor solution within the device and ensures that the ammonia precursor solution does not come into contact, or comes into contact only to a small extent, with an outer wall of the device. It is thus possible for the formation of deposits of the ammonia precursor solution on the outer wall of the device to be prevented.

Furthermore, the device is advantageous if the reaction space is divided by a cylindrical diverting element into a cylindrical gap and a central chamber, wherein the cylindrical gap and the central chamber are connected to one another by way of a diverting region, wherein the inflow connector is arranged at the cylindrical gap, the exhaust-gas flow from the cylindrical gap is conducted into the central chamber through the diverting region, and the supply device supplies the precursor solution in an axial direction into the central chamber through the diverting region.

The entire device preferably has a cylindrical housing. Here, the supply device is arranged on a face surface of the cylindrical housing, wherein the supply device is oriented in an axial direction toward said cylindrical housing. The outflow connector is preferably arranged on the opposite face side of the cylindrical housing. The inflow connector opens into the cylindrical housing through a circumferential surface in a tangential direction. The reaction space is arranged within the cylindrical housing of the device. The diverting element is then arranged in the direction toward the outflow connector proceeding from the supply device, which diverting element separates the cylindrical (ring-shaped) gap from the central chamber of the reaction space. The cylindrical gap is preferably open only in the direction of the supply device, and closed off on the opposite side. The gas that enters through the inflow connector therefore passes from the cylindrical gap into the central chamber in a diverting region in the vicinity of the supply device. In the diverting region there is preferably also a perforated screen, wherein the gas flow passes through said perforated screen on the path from the cylindrical gap into the central chamber. Said perforated screen preferably has a large central opening through which the supply device supplies the ammonia precursor solution into the central chamber. The spray cone of the supply device, as described further above, preferably extends through said central opening. It is preferable for a multiplicity of small openings to be arranged around the central opening, which small openings promote the entry of the gas into the central chamber. The impingement structure already described is arranged in an axial direction and in the direction of the outflow connector proceeding from the supply device (downstream of the diverting element), which impingement structure spans the cross section of the device and of the reaction space and may also comprise an electric heater. Additional catalytic converter substrate bodies may be situated so as to follow the impingement structure in an axial direction, which additional catalytic converter substrate bodies contribute to the conversion of the ammonia precursor solution into ammonia. Sensors and further components by way of which the generation of ammonia in the device can be assisted and/or monitored may also be arranged there. A sensor of the device may in particular comprise a lambda probe by way of which a lambda value can be determined.

The externally arranged cylindrical diverting element has the advantage that thermal insulation of the central chamber with respect to the outer wall of the device is realized, such that the ammonia precursor solution that is supplied into the central chamber cannot come into contact with the outer wall of the device. Furthermore, by way of the cylindrical diverting element, heating of the central chamber is realized, because the gas flowing in through the inflow connector flows around and heats the central chamber (through the cylindrical gap) before said gas enters the central chamber through the diverting region.

Furthermore, an exhaust-gas treatment device for the purification of the exhaust gases of an internal combustion engine is specified, having a device for generating ammonia as described here, and having an SCR catalytic converter which is arranged downstream of the device as viewed in the exhaust-gas flow direction, such that an ammonia-containing gas flow which emerges from the outflow connector flows through the SCR device, wherein the inflow opening is connected by way of a line branch to an exhaust line of the internal combustion engine, wherein, through the inflow opening, between 0.1% and 5.0% of the exhaust gas from the internal combustion engine flows into the reaction space.

The SCR catalytic converter of the exhaust-gas treatment device serves for achieving that, with the ammonia generated by the device, a reduction reaction can be generated in the exhaust-gas treatment device, in which reduction reaction nitrogen oxide compounds in the exhaust gas are reduced with the aid of the ammonia.

As already discussed, the line branch branches off from the exhaust line preferably upstream of the turbocharger, whereas the supply line opens into the exhaust line downstream of the turbocharger. For this reason, it is advantageous for only a relatively small exhaust-gas flow to be branched off from the main exhaust line and to flow into the device through the inflow connector. The main exhaust-gas flow can then be used in the turbocharger to generate mechanical energy for the supercharging of the internal combustion engine. Furthermore, such a small exhaust-gas partial flow of between 0.1% and 5% of the exhaust gas can be heated in a particularly effective manner with the aid of an electric heater, because relatively little thermal energy is required for this purpose. An SCR catalytic converter in which nitrogen oxide compounds in the exhaust gas can be reduced with the aid of the generated ammonia to form non-harmful substances is preferably arranged in the exhaust gas treatment device.

An exhaust-gas treatment device of said type is particularly preferably used for the purification of the exhaust gases of a diesel internal combustion engine. The exhaust-gas treatment device and the device are in particular also suitable for exhaust-gas purification in watercraft, rail vehicles, agricultural machines and construction machines etc. The device and the exhaust-gas treatment devices are particularly suitable in applications in which the exhaust gases of an internal combustion engine which is often used in the part-load range and in the low-load range are purified, because low exhaust-gas temperatures are particularly commonly encountered then.

In a particularly advantageous design variant, the exhaust-gas aftertreatment device has a particle filter which is arranged downstream of the device as viewed in the exhaust-gas flow direction, such that a gas flow emerging from the device from the outflow connector flows through the particle filter.

It has already been described further above that the device for generating ammonia may simultaneously also be designed for generating ozone. Ozone is particularly effective for removing hydrocarbon-containing deposits (in particular soot deposits) in a particle filter. Through the use of a described device in an exhaust-gas treatment device which has an SCR catalytic converter and a particle filter, it is made possible for the device to be used both for generating ammonia for the SCR catalytic converter and for generating ozone for the cleaning of the particle filter.

Furthermore, a method for operating an exhaust-gas treatment device for the purification of the exhaust gases of an internal combustion engine having a described device and having a particle filter is proposed, which method has at least the following steps:
a) supplying air from an intake line of the internal combustion engine into the device through the inflow connector;
b) generating ozone in the device such that an ozone-containing gas flow is generated in the device and emerges from the device at the outflow connector;
c) supplying the ozone to the particle filter via a supply line;
d) regenerating particle filter, wherein soot deposits in the particle filter are converted using ozone.

The supplying of air into the device or into the reaction space of the device may be performed in targeted fashion in particular if ozone is required for the regeneration of a particle filter.

The advantages and design features highlighted in conjunction with the described device and the described exhaust-gas aftertreatment device are transferable analogously to said method. The same applies to the advantages and embodiments described in conjunction with the method, which can be transferred analogously to the proposed device and to the exhaust-gas treatment device.

The invention and the technical field of the invention will be explained in more detail below on the basis of the figures. In particular, it should be noted that the figures and in particular the proportions illustrated in the figures are merely schematic. In the figures:

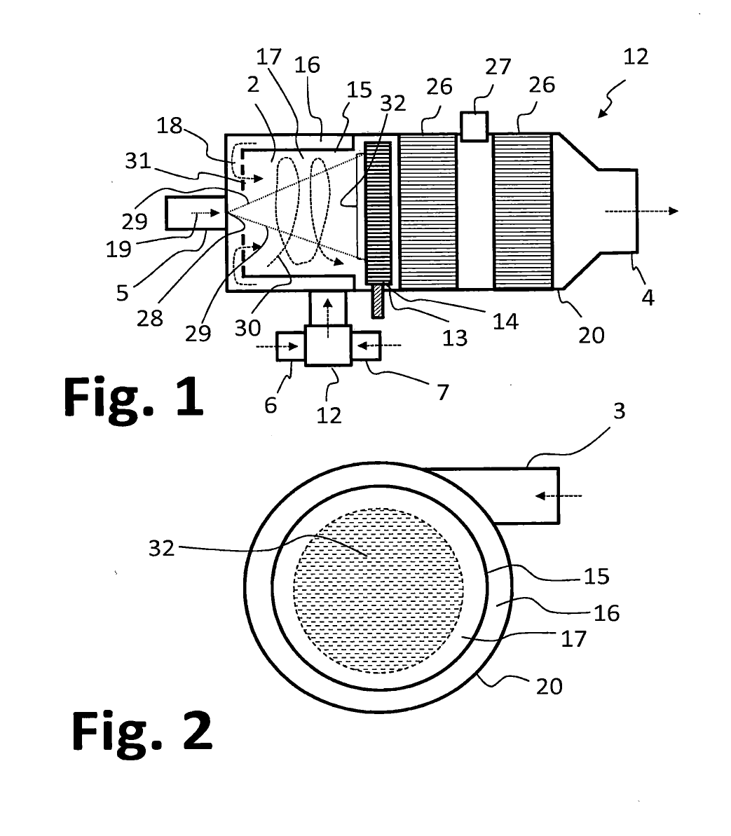

FIG. 1: shows a device for generating ammonia from an ammonia precursor solution,

FIG. 2: shows a cross section through a device of said type for generating ammonia, and

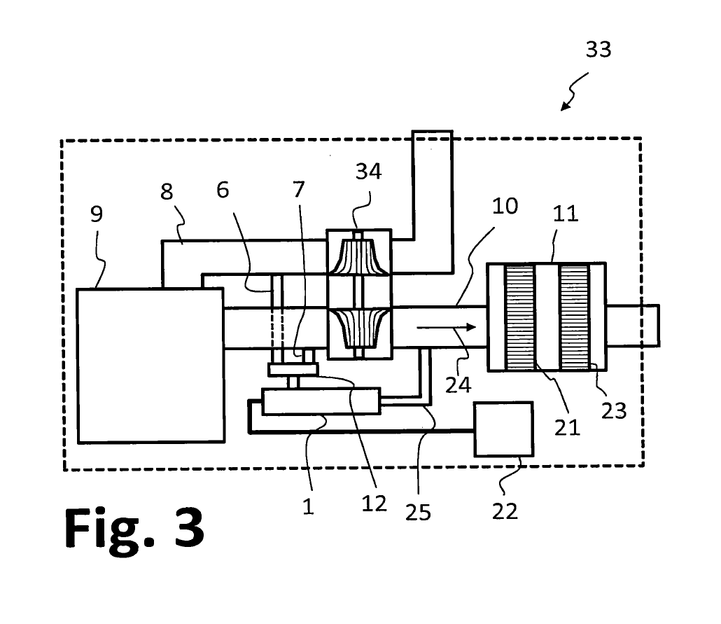

FIG. 3: shows a motor vehicle having a device for generating ammonia.

FIG. 1 shows a device 1 which has a cylindrical housing 20. On a face side of the device 1, there is arranged a supply device 5 by way of which an ammonia precursor solution (e.g. a urea-water solution) can be supplied into a reaction space 2 of the device 1. On the opposite face side of the device 1, there is situated an outflow connector 4 at which an ammonia-containing gas flow can flow out of the device 1. On the circumferential surface of the device 1, there is arranged, in a tangential orientation, an inflow connector 3 via which a gas flow can flow into the reaction space 2 of the device 1. The inflow connector 3 is connected to a first connecting line 6 via which an exhaust-gas flow that is branched off from an exhaust line can be supplied into the device 1. The inflow connector 3 is furthermore connected to a second connecting line 7, via which an air flow, which may for example be branched off from an intake line of an internal combustion engine, can flow into the device 1. A diverting element 15 is provided in the (single) reaction space 2 of the device 1, which diverting element separates a cylindrical gap 16 from a central chamber 17 in the reaction space 2. The gas flow entering through the inflow connector 3 firstly enters the cylindrical gap 16 and is subsequently diverted, in a diverting region 18, into the central chamber 17.

The supply device 5 preferably comprises a nozzle 28 which sprays the ammonia precursor solution in a spray cone 29 onto an impingement region 32 arranged within the reaction space 2. In the diverting region 18, there is also provided a perforated screen 31 through which the spray cone 29 of the supply device 5 extends. For this purpose, the perforated screen 31 has a central opening. Furthermore, the perforated screen 31 has a multiplicity of relatively small openings (arranged around the central opening) through which the exhaust-gas flow can pass from the cylindrical gap 16 into the central chamber 17. Owing to the tangential arrangement of the inflow connector 3 at the reaction space 2 or at the device 1, a vortex flow 30 of the gas flow is generated within the reaction space 2.

An impingement region 32 for the ammonia precursor solution that is supplied by way of the supply device 5 is arranged on an electric heater 13 in the form of an electrically heatable honeycomb body 14, which, as viewed in the exhaust-gas flow direction and in the axial direction 19, is situated downstream of the supply device 5 proceeding from the inflow connector 3 and the supply device 5. It is also possible for yet further components (such as for example a catalytic converter substrate body 26 or a sensor 27), by way of which the reactions within the device 1 can be monitored or influenced in a controlled manner, to be provided in the device 1 downstream of the electric heater 13 as viewed in the exhaust-gas flow direction.

FIG. 2 shows a cross section through the device from FIG. 1, in which the tangentially arranged inflow connector 3, the diverting element 15, the cylindrical gap 16 and the central chamber 17, and also the impingement region 32 and the housing 20, are visible.

FIG. 3 shows a motor vehicle 33 having an internal combustion engine 9 and having an exhaust-gas treatment device 11 which is configured for the purification of the exhaust gases of the internal combustion engine 9. The exhaust-gas treatment device 11 is connected via an exhaust line 10 to the internal combustion engine 9. The internal combustion engine 9 furthermore has an intake line 8 via which the internal combustion engine draws in air (from the surroundings). The air that passes via the intake line 8 to the internal combustion engine 9 is supercharged and/or compressed by a turbocharger 34, wherein the turbocharger 34 is driven by the exhaust-gas flow in the exhaust line 10. An SCR catalytic converter 21 for performing a selective catalytic reduction and a particle filter 23 for filtering particles in the exhaust-gas flow are arranged in the exhaust-gas treatment device 11. The motor vehicle 33 also has a device 1 by way of which an ammonia-containing gas flow can be generated. The device 1 is preferably also suitable for generating ozone by way of which particles deposited in the particle filter 23 can be reduced. The device 1 is supplied with air from the intake line 8 via a first connecting line 6. The device 1 is furthermore supplied with exhaust gas from the exhaust line 10 via a second connecting line 7. The device 1 has a valve 12 by way of which the exhaust gas from the second connecting line 7 and the air from the first connecting line 6 can be mixed in targeted fashion and supplied to the device 1. The device 1 is furthermore supplied with ammonia precursor solution from a precursor solution tank 22.

The described device is particularly advantageous because it firstly makes it possible for ammonia for performing the SCR method in an SCR catalytic converter to be provided in an effective manner. At the same time, the device also makes it possible to provide ozone by way of which soot deposits in a particle filter can be burned off in an effective manner.

### LIST OF REFERENCE SYMBOLS

1 Device
2 Reaction space
3 Inflow connector
4 Outflow connector
5 Supply device
6 First connecting line
7 Second connecting line
8 Intake line
9 Internal combustion engine
10 Exhaust line
11 Exhaust-gas treatment device
12 Valve
13 Electric heater
14 Electrically heatable honeycomb body
15 Diverting element
16 Cylindrical gap
17 Central chamber
18 Diverting region
19 Axial direction
20 Housing
21 SCR catalytic converter
22 Precursor solution tank
23 Particle filter
24 Exhaust-gas flow direction
25 Supply line
26 Catalytic converter substrate body
27 Sensor
28 Nozzle
29 Spray cone
30 Vortex flow
31 Perforated screen
32 Impingement structure
33 Motor vehicle
34 Turbocharger

1. A device for generating ammonia from an ammonia precursor solution, comprising: a reaction space with an inflow connector through which a gas flow can flow into the reaction space, with an outflow connector through which an ammonia-containing gas flow can exit the reaction space, and with a supply device configured to supply ammonia precursor solution into the reaction space, wherein the inflow connector is connected to a first connecting line through which air can flow from an intake line of an internal combustion engine into the reaction space, and wherein the inflow connector is furthermore connected to a second connecting line through which exhaust gas can flow from an exhaust line of the internal combustion engine into the reaction space.

2. The device as claimed in claim 1, wherein, between the first connecting line and the second connecting line, there is arranged a valve configured to supply selectively exhaust gas or air to the reaction space.

3. The device as claimed in claim 2, wherein the valve, is configured to generate a mixture of air and exhaust gas which can be supplied to the reaction space.

4. The device as claimed in claim 1, wherein an electric heater is arranged in the reaction space.

5. The device as claimed in claim 4, wherein the electric heater comprises an electrically heatable honeycomb body.

6. The device as claimed in claim 1, wherein the inflow connector is arranged tangentially at the reaction space.

7. The device as claimed in claim 1, wherein the reaction space is divided by a cylindrical diverting element into a cylindrical gap and a central chamber, wherein the cylindrical gap and the central chamber are connected to one another by way of a diverting region, wherein the inflow connector is arranged at the cylindrical gap, the exhaust-gas flow from the cylindrical gap is conducted into the central chamber through the diverting region, and the supply device supplies the precursor solution in an axial direction into the central chamber through the diverting region.

8. An exhaust-gas treatment device for the purification of the exhaust gases of an internal combustion engine comprising: a device for generating ammonia as claimed in claim 1, and an SCR catalytic converter which is arranged downstream of the device as viewed in the exhaust-gas flow direction, such that an ammonia-containing gas flow which emerges from the outflow connector flows through the SCR catalytic converter, wherein the inflow connector is connected by a line branch to an exhaust line of the internal combustion engine, wherein, through the inflow connector, between 0.1% and 5% of the exhaust gas from the internal combustion engine flows into the reaction space.

9. The exhaust-gas treatment device as claimed in claim 8, comprising a particle filter which is arranged downstream of the device as viewed in the exhaust-gas flow direction, such that a gas flow emerging from the outflow connector of the device flows through the particle filter.

10. A method for operating an exhaust gas treatment device for the purification of the exhaust gases of an internal combustion engine comprising a device as claimed in claim 1 and a particle filter, the method comprising:
supplying air from an intake line of the internal combustion engine into the device through the inflow connector;
generating ozone in the device such that an ozone-containing gas flow is generated in the device and emerges from the device at the outflow connector;
supplying the ozone to the particle filter via a supply line;
regenerating particle filter, wherein soot deposits in the particle filter are converted using ozone.
